(19) United States
(12) Patent Application Publication
(10) Pub. No.: US 2020/0359835 A1
(43) Pub. Date: Nov. 19, 2020

(54) COFFEE DISPENSING MACHINE

(71) Applicant: CMA MACCHINE PER CAFFE' S.R.L., Susegana TV (IT)

(72) Inventors: Beppino CEOTTO, Susegana TV (IT); Andrea ZONELLI, Susegana TV (IT)

(21) Appl. No.: 16/756,915

(22) PCT Filed: Oct. 19, 2018
(86) PCT No.: PCT/IB2018/058145

§ 371 Date: Apr. 17, 2020

(30) Foreign Application Priority Data
Oct. 20, 2017 (IT) 102017000119289

(51) Int. Cl. A47J 31/46; A47J 31/56

(52) U.S. Cl. CPC A47J 31/465; A47J 31/469; A47J 31/56

(57) ABSTRACT

A machine (1) for dispensing espresso coffee is described, comprising at least one boiler (3) for containing and heating water, at least one container (4) suitable to contain the water for dispensing the coffee, at least one inlet hydraulic circuit (5) suitable to connect said boiler (3) and said container (4) to a water supply line, at least one coffee dispensing unit (6), at least one outlet hydraulic circuit (7) suitable to connect at least said container (4) to said coffee dispensing unit (6). The inlet hydraulic circuit (5) comprises at least one inlet block (8) having at least one water passage duct (9) provided with at least one inlet port (9a) connectable to a water supply line, with at least one passage mouth (9b) communicating with said boiler (3) and with at least one outlet port (9c) fluidically connected with at least one water distributing element (80′, 80″) to distribute the water to at least one container (4). The distributing element is provided with at least one inlet opening (82′, 82″) fluidically connectable to the outlet port (9c) of the inlet block (8) and with at least one distribution opening (83′, 83″) for the fluidic connection to said container (4).

### FIELD OF THE INVENTION

The present invention concerns a machine for dispensing espresso coffee.

### KNOWN PRIOR ART

The machines for dispensing espresso coffee of the known type, mostly intended for professional use, generally comprise a supporting frame combined with at least one boiler for heating the water, one or more containers, for example heat exchangers housed inside the boiler, and one or more coffee dispensing units connected to a relative heat exchanger.

More particularly, the boiler is provided with a resistance adapted to heat the water contained therein, and the exchangers, which receive the heat by conduction from the boiler, are adapted to maintain the water temperature and pressure within an optimal range for the correct dispensing of the coffee.

In fact, as is known, the water used to obtain espresso coffee is the one contained in the heat exchanger.

Furthermore, the machine can be provided with a hot water dispensing unit and with a steam dispensing unit, both connected to the boiler.

These coffee machines generally provide a connection to the water supply network, which is then connected to the boiler and heat exchanger by means of an inlet hydraulic circuit.

More specifically, since the operations of these machines provide a plurality of steps, such as the filling of the boiler to a minimum level in order to avoid burning the resistance, the subsequent complete filling of the boiler and container, the dispensing of the coffee and the unloading of the boiler, the inlet hydraulic circuit comprises a plurality of piping, fittings, valves, etc. for the connection to the water supply network and for the execution of the operating steps.

Similarly, also the connection of the boiler and heat exchanger to the dispensing units is obtained by means of an outlet hydraulic circuit.

As is known, both the inlet and outlet hydraulic circuits comprise a plurality of tubes, valves and sensors of various types, such as level sensors, pressure sensors, etc. Wiring is added to the tubes necessary for channeling the water and steam in order to achieve the electric connections.

As a result, coffee machines are considerably complex both in terms of the constructive and maintenance profiles.

Documents EP2741645 and EP2741646 suggest a possible solution to the aforesaid drawbacks by providing a machine for dispensing coffee wherein the connectors connecting the inlet and outlet circuits of the machine to the various components are simplified.

Object of the present invention is to further improve the machine for dispensing coffee so that to provide both a simple-to-obtain and flexible machine that also allows to simply and easily adapt the hydraulic circuit to the dimensions of the machine, and, in particular, to the number of dispensing units provided therein (and, therefore, to the number of exchangers in the machine).

More specifically, object of the present invention is to simplify and rationalize the distribution of the water dispensed from the supply network to one or more exchangers of the machine, and, therefore, to the respective dispensing units by means of an inlet hydraulic circuit.

Another object of the present invention is to provide a machine comprising an inlet hydraulic circuit adaptable, during the construction step, to the number of dispensing units to be mounted inside the machine and which can simultaneously provide a simple and quick access to the components of the hydraulic circuit for the maintenance operations and which can also allow the quick replacement of the components of the hydraulic circuit in the event of malfunctions.

A further object of the present invention is to provide a machine for dispensing coffee, provided with an improved water flow control in the outlet hydraulic circuit connecting the container, for example the exchanger, to the coffee dispensing unit.

### SUMMARY OF THE INVENTION

These and other objects are achieved by the machine for dispensing coffee according to the present invention. Further features/aspects are described in the dependent claims.

It should also be noted that the present invention concerns a distributing element for the distribution of water to at least one container of the machine for dispensing coffee according to claim 19, as well an assembly according to claim 29 comprising an inlet block and one or more distributing elements to make up an inlet hydraulic circuit of a machine for dispensing coffee. It should immediately be noted that the features/aspects described and/or claimed with reference to the machine can concern the distributing element according to claim 19 and/or the assembly according to claim 29.

The machine for dispensing coffee according to the present invention comprises:

at least one boiler, for containing and heating the water;

at least one container suitable to contain the water for dispensing the coffee;

at least one inlet hydraulic circuit suitable to connect said boiler and said container to a water supply line;

at least one coffee dispensing unit;

at least one outlet hydraulic circuit suitable to connect said at least one container to said coffee dispensing unit.

The machine is characterized in that said inlet hydraulic circuit comprises at least one inlet block and at least one distributing element to distribute the water from said inlet block to said container. The inlet block is provided with at least one duct for the water passage, with at least one inlet port connectable to a water supply line, with at least one passage mouth communicating with said boiler and with at least one outlet port fluidically connected with at least one water distributing element to distribute the water to at least one container. The at least one distributing element is provided with at least one inlet opening connected to the outlet port of the inlet block and at least one distribution opening for the fluidic connection to the container and, therefore, for the adduction of water to said container.

Advantageously, the at least one distributing element is a component separable from the inlet block that is fluidically connected thereto. This way, one or more distributing elements can advantageously be connected, during the construction of the machine, to the inlet block according to the constructive requirements and, preferably, to the number of dispensing units and/or number of containers (for example heat exchangers) provided inside the machine.

Moreover, the one or more distributing elements might be replaced in the event of a malfunction, or one or more distributing elements can be added or removed whenever the machine is modified by increasing or decreasing the dispensing units.

According to an aspect of the present invention, the distributing element fluidically connectable to the inlet block is a “modular” distributing element or “distribution module”, given that this element can be combined with the inlet block and/or with one or more additional distributing elements.

According to a preferred aspect of the invention, two or more containers of the machine and/or two or more dispensing units of the machine are fluidically connected to a respective distributing element.

Moreover, according to an aspect of the invention, the distributing elements are equal to one another and can therefore be easily replaced, thus reducing the types of components used inside the machine and to be stocked in the warehouse for construction and maintenance operations.

Another object of the present invention is a machine for dispensing coffee comprising:

at least one boiler, for containing and heating the water;

at least one container suitable to contain the water for dispensing the coffee;

at least one inlet hydraulic circuit suitable to connect said boiler and said container to a water supply line;

at least one coffee dispensing unit;

at least one outlet hydraulic circuit suitable to connect said at least one container to said coffee dispensing unit

the machine being characterized in that said outlet hydraulic circuit comprises at least one outlet block interposed between said boiler and at least one coffee dispensing unit and in which at least one water dispensing duct is predefined and communicates with said container on one part and with said coffee dispensing unit on the other, and at least one return duct, preferably distinct from said dispensing channel and communicating with said coffee dispensing unit on one part and with said container on the other, and wherein at least one regulating member is adapted to regulate the water flow recirculation through said dispensing duct and/or said return duct into the container.

It should be noted that the term water recirculation herein and hereinafter refers the flow of water reaching the dispensing unit from the container and through the dispensing duct, and which is returned to the container through the return duct when not dispensed by the unit. A water recirculation, known as convective motion or thermosiphon circulation of the machine, is therefore provided and used to regulate the temperature of the dispensing unit.

According to an aspect of the invention, the flow regulating member, such as, for example, a valve, is arranged along the water recirculation path to regulate the flow and to effectively regulate the temperature of the dispensing unit.

According to a possible embodiment, the regulating member—such as, for example, a valve—is arranged to regulate the flow in the dispensing duct, which channels water from the container to the dispensing unit. However, the possibility to arrange the regulating member in the return duct, which channels water from the dispensing unit to the container, is not to be excluded.

It should be noted that the presence of the regulating member in the outlet hydraulic circuit for regulating the water recirculation flow can be used in combination or independently with respect to the features of the inlet circuit of the machine according to claim 1.

### BRIEF DESCRIPTION OF THE DRAWINGS

Further features and advantages of the present invention will become clearer in the description of embodiments of machine for dispensing espresso coffee, illustrated by way of example, but without limitations, in the accompanying drawings, in which:

FIG. 1 is a partial perspective view of a possible embodiment of the machine according to the present invention;

FIG. 2 is a partial perspective view of the machine in FIG. 1;

FIG. 3 is a detailed perspective view of a possible embodiment of the inlet hydraulic circuit;

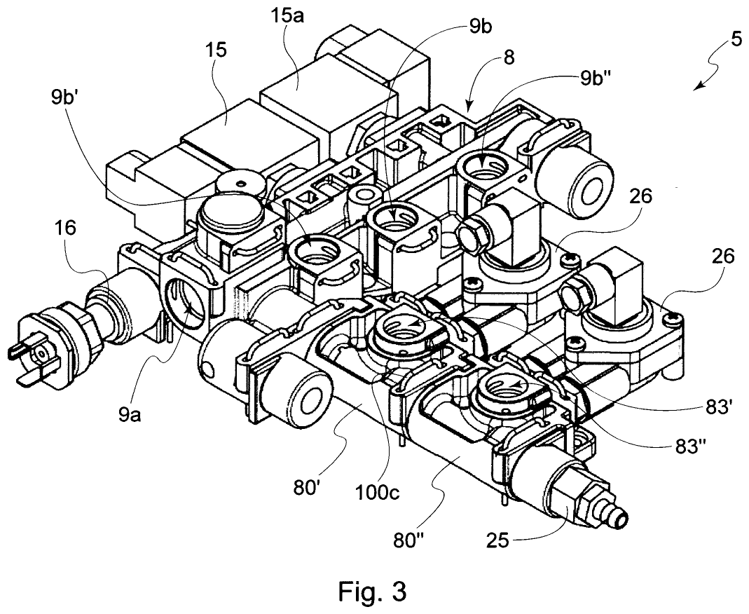

FIG. 4 is an exploded view of one part of the inlet hydraulic circuit in FIG. 3;

FIG. 5 is a front view of the boiler, dispensing units and outlet hydraulic circuit of the dispensing machine according to the present invention;

FIG. 5A is a cross-sectional view according to the plane A-A of FIG. 5.

### METHOD FOR IMPLEMENTING THE INVENTION

With reference to the accompanying figures, a possible embodiment of the machine for dispensing espresso coffees according to the present invention, and globally denoted in the figures as reference number 1, will now be described.

It should be noted that the components of the machine 1 are in fluidic communication with one another, in other words, the water for dispensing the coffee is channeled among the various components of the machine 1 by means of suitable ducts or tubes, or similar fluidic channeling means of the known art.

In other words, the expressions “fluidic connection” or fluidically connected” are herein used to indicate that a component of the machine is connected to another component of the machine to allow the transfer of fluid between them.

In the accompanying figures, the fluidic connection between the components of the machine is schematically depicted by means of lines and arrows indicating the running direction of the fluid.

It should also be noted that the terms “downstream” and “upstream” are used to indicate the position of a component of the machine with respect to one another, with reference to the flow direction of the fluid inside the machine itself. Moreover, the term “interposed” is used to indicate that a component is arranged between two other components to which it is fluidically connected.

The machine 1 comprises at least one boiler 3 suitable for containing and heating the water, at least one container 4 suitable to contain the water for dispensing the coffee, at least one inlet hydraulic circuit 5 suitable to connect the boiler 3 and the container 4 to a water supply line, and at least one coffee dispensing unit 6 connected to the container 4 by means of an outlet hydraulic circuit 7.

Conveniently, the machine 1 comprises a supporting structure 2 and, according to a possible embodiment, the boiler 3 can be combined with this structure 2.

The water supply line generally consists of the water supply network, however possible embodiments wherein the water supplied to the machine comes from a suitable tank are not to be excluded.

More particularly, the boiler 3 comprises a container for the water coming from the supply line and at least one heating element, generally of the electric or gas type, adapted for heating the water collected inside the container itself. The heating element can be arranged inside this container, especially in case of an electric resistance, or outside thereof, especially in case of a gas heating element.

This heating element is generally operatively connected to a pressure gauge (or similar pressure detecting means), which is in turn connected to the boiler 3 and adapted to change the temperature thereof depending on the pressure detected inside the boiler 3. The pressure gauge therefore intervenes on the heating element in order to maintain the pressure inside boiler 3 practically constant.

The volume defined by the container 4 is separated from the one delimited by the boiler 3.

According to a possible embodiment, such as, for example, the embodiment shown in the figures, the container 4 is of the type of an exchanger at least partially contained inside the boiler 3 and the water collected therein is conduction heated by the water contained in the boiler itself. However, alternative embodiments, wherein the container 4 is arranged outside of the boiler 3 and the water contained therein comes from the boiler itself or is heated by means of an autonomous heat source, are not to be excluded.

The container 4 is therefore adapted to maintain the water within an optimal temperature and pressure range for the correct dispensing of the espresso coffee.

According to a preferred embodiment, the number of containers 4 is equal to the number of coffee dispensing units 6.

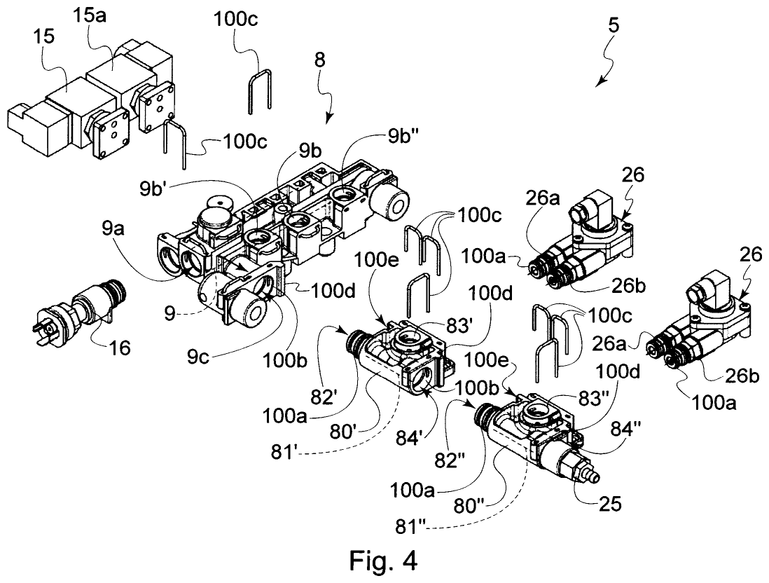

According to a possible embodiment, the inlet hydraulic circuit 5 comprises at least one inlet block 8, preferably monolithic, provided with at least one water passage duct 9 (schematically shown in FIG. 4) provided with at least one inlet port 9a connectable to the supply line, with at least one passage mouth 9b communicating with the boiler 3 and with at least one outlet port 9c fluidically connected with one or more water distributing elements 80′, 80″ to distribute the water to at least one container 4. In other words, the outlet port 9c is connected to the container 4 by means of at least one water distributing element 80′, 80″.

More specifically, the passage duct 9 (schematically shown in FIG. 4) is so that to put the inlet port 9a in fluidic communication with the at least one outlet port 9c and the at least one passage mouth 9b.

The distributing element 80′, 80″ comprises a main body provided with at least one inlet opening 82′, 82″ fluidically connectable to the outlet port 9c of the inlet block 8 and to the at least one distribution opening 83′, 83″ for the fluidic connection to the container 4.

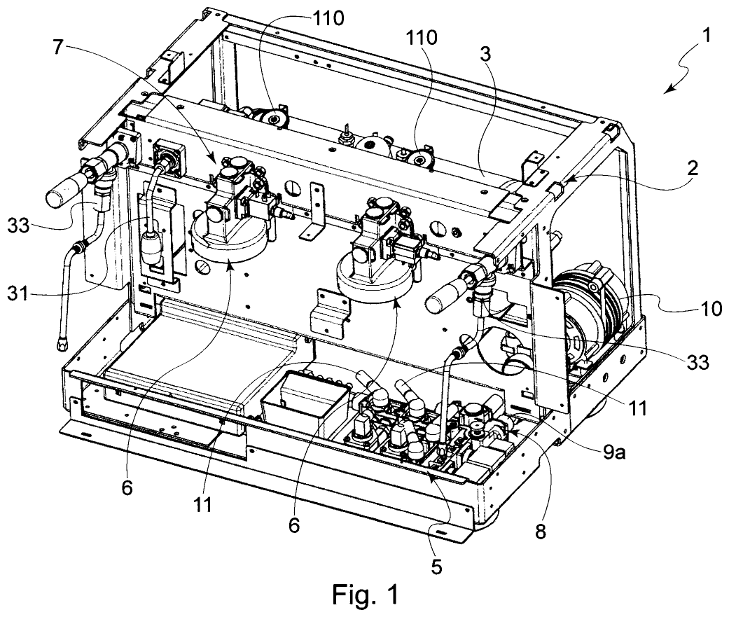

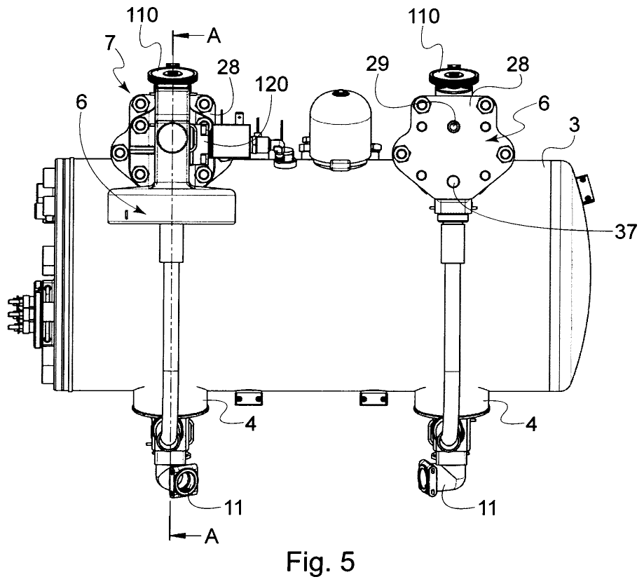

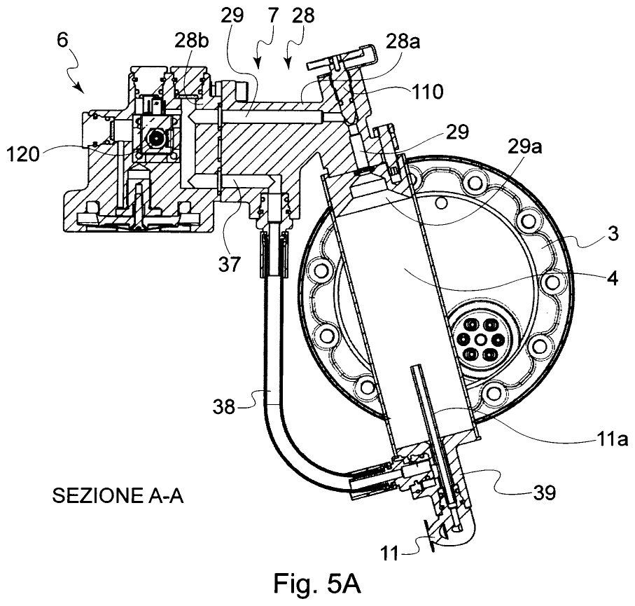

The distribution opening 83′, 83″ is connected to the container 4 by means of a tube or duct 11 (partially visible in FIG. 1 and in FIG. 5). As will become clearer hereinafter, a meter 26, preferably volumetric, is fluidically interposed between said inlet opening 82′, 82″ and the distribution opening 83′, 83″ to allow the outflow of a predetermined quantity of water through this opening.

According to this embodiment, the distribution opening 83′, 83″ cannot directly be fluidically connected with the inner duct passage (81′, 81″ schematically shown in the figures) of the distributing element and therefore with the inlet opening 82′, 82″, however, as mentioned, a meter 26 is fluidically interposed between them.

As is known, the end section of the duct 11 connected to the container 4 can comprise an injector 11a protruding inside the lower portion of the recipient 4 itself.

Conveniently, the inlet circuit 5 comprises at least one pump 10 connected to the water supply line on one part and to the inlet port 9a of the inlet block 8 on the other. This way, the water coming through the port 9a is supplied both to the passage mouth 9b and to the outlet port 9c and, from here, to one or more containers 4 by means of one or more distributing elements 80′, 80″.

The distributing element 80′, 80″ comprises at least one outlet opening 84′, 84″. In detail, the distributing element comprises an inner channel 81′, 81″ that fluidically connects the inlet opening 82′, 82″ and the outlet opening 84′, 84″.

Advantageously, as will become clearer hereinafter, the outlet opening 84′, 84″ of the distributing element 80′, 80″ allows the connection to a further component, for example a valve, such as, for example, a high pressure valve 25 or overpressure valve. In alternative, the outlet opening 84′, 84″ is used to connect to a further distributing element, therefore making up a plurality of modular elements connected to one another, preferably one after the other, i.e. in series.

It should also be noted that, if unused, the outlet opening 84′, 84″ can conveniently be closed by means of a suitable lid or cap.

According to a preferred embodiment, the machine 1 according to the invention comprises one or more distributing elements 80′, 80″ fluidically connected to one another, preferably one after the other (in series).

More specifically, according to a possible embodiment, the outlet opening 84 of a distributing element 80′ is connected to the inlet opening 82″ of a further distributing element 80″ and so forth, depending on the number of distributing elements 80′, 80″ present inside the circuit.

According to an advantageous aspect of the present invention, the distributing element is therefore a modular element that can advantageously be coupled to a further distributing element. It can also be simply replaced, if required, therefore reducing the quantity of components to be stocked in the warehouse.

According to an aspect of the present invention, it should be noted that the distributing elements 80′, 80″ are preferably equal to one another, i.e. the elements have the same features.

In the embodiment shown in the figures, the inlet hydraulic circuit 5 comprises two distributing elements 80′ and 80″ connected to one another for example, and the first of which is also fluidically connected to the inlet block 8.

According to an aspect of the present invention, the number of distributing elements used is equal to the number of containers 4. In other words, each container 4 is fluidically combined with a respective distributing element 80′, 80″. According to an aspect of the present invention, the machine comprises two or more containers 4 (and therefore two or more dispensing units 6) and each container 4 is fluidically connected to a distribution opening 83′, 83″ of a respective distributing element 80′, 80″.

Since in the embodiment shown in the figures, the machine 1 comprises two coffee dispensing units 6 and two containers 4, preferably the inlet hydraulic circuit 5 comprises two distributing elements 80′ and 80″, each connected to a respective container 4 by means of a duct 11 connectable to the distribution opening 83′, 83″ of the respective distributing element.

It should also be noted that according to a possible alternative embodiment not shown in the figures, the distributing element can provide more distribution openings, each connected to a respective container. In other words, two or more containers 4 can be connected to a distributing element provided with two or more distribution openings, one for each respective containers.

According to an aspect of the present invention, a distributing element 80′, 80″ is coupled by coupling means 100a, 100b, preferably in a reversible way, to the inlet block 8 and/or to at least one further distributing element 80′, 80″. More in detail, according to a possible embodiment such as, for example, visible in the figures, a first distributing element 80′ is coupled to the outlet port 9c of the inlet block 8 and a second distributing element 80″ is in turn coupled to the first distributing element 80″.

In other words, the distributing elements 80′, 80″ and the inlet block 8, and in particular the part in which the outlet port 9c is arranged, are configured to determine not only the fluidic connection between these components, but also to allow the coupling, preferably in a reversible way, between them.

Advantageously, the coupling of reversible type allows, preferably following the intervention of an operator, to determine the release, and therefore decoupling, of the components so that one or more thereof can be easily removed/replaced.

According to an aspect of the present invention, the coupling means 100a, 100b, preferably of reversible type, comprise a first coupling portion 100a arranged on said distributing element 80′, 80″ and at least one second coupling portion 100b arranged on said inlet block 8, or on a further distributing element 80′, 80″, or vice-versa. The coupling means 100a, 100b are configured to cooperate with one another so that to achieve a reversible coupling between them.

Generally, according to an aspect of the present invention, the second coupling portion 100b is adapted to receive, or catch, at least part of the first coupling portion 100a, or vice-versa, so that to achieve a reversible coupling between them.

For example, the first and second coupling means 100a, 100b can substantially be configured in a complementary way between them. For example, the coupling means can be of the male-female type or the snap-fit type, with at least one coupling portion 100a at least partially inserted inside a second coupling portion 100b.

More specifically, according to an aspect of the present invention, the inlet opening 82′, 82″ of said distributing element 80′, 80″ is complementarily configured for the coupling, preferably of reversible type, to said outlet port 9c of said inlet block 8 or to said outlet opening 84′, 84″ of a further distributing element 80′, 80″.

For example, hydraulic coupling means of the known type can be used, such as, for example, quick coupling means, wherein complementary parts cooperate with one another preferably by inserting, for example with interference, a coupling portion present on a first component into a second coupling portion present on a second component. According to an aspect of the present invention, the second coupling portion 100b forms a seat adapted to receive at least part of the first coupling portion 100a, or vice-versa, so that to achieve a reversible coupling between them.

It should immediately be noted that the term “seat” is herein used to indicate at least one coupling portion 100b intended to receive, or catch, at least part of a first coupling portion 100a, which is preferably protruding, or vice-versa.

According to a possible embodiment, the outlet port 9c and/or outlet opening 84′, 84″ of a distributing element defines a coupling portion 100b, and in particular a seat—for example circular in shape—configured to receive at least part of the coupling portion 100a, preferably jutting out from said distributing element at the inlet opening 82′, 82″ of the distributing element.

It should be noted that suitable fluidic sealing elements, for example one or more ring-shaped gaskets (and in particular of the O-ring type), can be arranged at one or both coupling portions 100a, 100b to ensure an effective fluidic seal once the parts have been coupled to one another.

It should be noted that the aforesaid reversible coupling is so that the components can be coupled and therefore constrained to one another in order to withstand the loads and stresses to which they are subjected during the normal operations of the machine 1, therefore avoiding any undesired release or removal, if not exceeding a predefined effort (or stress) value, which is generated when wanting to remove one of the components, this stress generally occurs during the manual intervention of a technician or by means of tools suitable for the purpose.

According to an aspect of the present invention, restraining means 100c to restrain said at least one distributing element 80′, 80″ in a position mutually coupled with the inlet block 8 and/or with at least one further distributing element 80′, 80″ can also be provided.

According to a possible embodiment, the restraining means are generally arranged so that to prevent the removal of the components coupled to one another.

According to a possible embodiment, the substantially U-shaped elements, for example in the form of a U-bolt, for example made of a metal material, are mounted at the coupling means 100a, 100b, to interfere with at least one of these coupling portions and therefore to prevent an undesired removal from the mutual coupling position.

Such as, for example, visible in the figures, it should be noted that similar restraining elements 100c can also be used to restrain the water ducts or tubes (not shown in the figures) in coupling positions with openings or ports, for example with the passage mouth 9b or with the water distribution opening 83′, 83″ of the distributing element.

Moreover, it should be noted that the outlet block 8 and the distributing element 80′, 80″ can each provide positioning elements 100d configured complementarily to elements 100e arranged on the other component to which the first component is coupled, or vice-versa. For example, according to a possible embodiment, a protruding element 100d can be arranged on the outlet block 8 and/or on the distributing element 80′, 80″ to be received in the mutual coupling position in a corresponding recess 100e arranged on the other component to which it is coupled, for example selected between the outlet block 8 and/or a further distributing element. For example, these means 100e 100d can determine an interlocking coupling of complementary parts.

According to an aspect of the present invention, at least one meter 26, preferably of the volumetric type, is combined with said distributing element 80′, 80″. More specifically, preferably the inlet circuit 5 comprises a number of meters 26, corresponding to the number of distribution openings 83′, 83″, where each meter 26 is fluidically connected in proximity of the relative distribution opening 83′, 83″ and is adapted to measure the flow of water crossing it and which therefore ends up in the corresponding container 4.

According to an aspect of the present invention, the meter 26 is fluidically interposed between the inlet opening 82′, 82″ and the distribution opening 83′, 83″ of the distributing element 80′, 80″.

Advantageously, according to an aspect of the invention, the meter 26 is arranged outside of the distributing element 80′, 80″ and is coupled to it, preferably in a reversible way. For example, coupling means 100a, 100b, similar to those used for the coupling of the distributing element to the inlet block or to a further distributing element, can be used. More specifically, the meter 26 can be provided with a jutting portion 100a intended to be at least partly received in a corresponding coupling portion 100b of the distributing element forming a seat for its insertion.

More specifically, according to an aspect of the present invention, two jutting ducts 26a, 26b can be provided for the fluidic connection, as well as for the coupling and therefore for constraining the meter to the distributing element.

The first duct 26a is fluidically connected with the inner passage duct 81′, 81″ of the distributing element, which is in turn provided with the inlet opening 82′, 82″ so that to receive the water. The water passing through the meter comes out of the second duct 26b, which is fluidically connected with the distribution opening 83′, 83″ of the distributing element.

This way, a predetermined and/or measurable quantity of water can be provided to the container 4 connected to the distribution opening 83′, 83″.

Advantageously, according to an aspect of the present invention, the inlet block 8 and/or the at least one distributing element 80′, 80″ is made of a material selected from the group comprising: plastic, stainless steel and aluminum for food use. In detail, the use of plastic material is particularly advantageous given it is both economic to implement and particularly resistant. Obviously, different known implementation methods can be used, for example if plastic material is used, the inlet block 8 and/or the at least one distributing element 80′, 80″ can be obtained by injection molding.

It should also be noted that the inlet block 8 can comprise further connecting mouths 9b′, 9b″ in addition to the passage mouth 9b connected to the boiler, such as, for example, in the embodiment shown in the figures and in which there are the passage mouths 9b′ and 9b″ that might be used to connect to further components of the machine, for example as a hot water mixing line or to unload the circuit.

Moreover, it should be noted that the inlet block 8 can further comprise valves, faucets, sensors, filters and other known components which are suitably used to regulate the flow of water into components of the machine. For example, as visible in the accompanying figures, the inlet block 8 can comprise a load valve 15 of the boiler 3, in addition to a further control valve 15a which can be, for example, used to control the water being unloaded from the boiler. Moreover, the inlet block can comprise at least one pressure sensor 16, for example a pressure gauge.

As is known, the load valve of the boiler 15, for example of the electrovalve type, can be connected to a lever sensor inserted in the boiler; so that to control the opening of the valve 15 to allow the outflow of water towards the passage mouth 9b when the level of water inside the boiler 3 goes below the predetermined value of reference of the level sensor.

Moreover, as known for example from EP2741645, the inlet block 8 can comprise a water unloading duct in addition to a low pressure valve allowing to prevent water from reaching the outlet port 9c until a minimum predetermined pressure value is reached. This low pressure valve can be, for example, of the mechanical type and is adapted to open once a first predetermined pressure value is reached.

Moreover, the inlet circuit 5 can comprise a high pressure valve 25 adapted to open once a second predetermined pressure value is reached, this high pressure valve 25 practically acts as a safety valve given it is adapted to prevent the pressure inside the circuit from exceeding a maximum predetermined threshold value. As mentioned, according to a possible embodiment, the high pressure valve 25 is connected to the last distributing element 80″ present in the circuit and is preferably connected to the outlet opening 84″ of the distributing element.

Moreover, the machine 1 can comprise a hot water dispensing unit 31 and a steam dispensing unit 33 such as, for example, visible in FIG. 1.

Although not shown in the accompanying figures, it should be noted that these hot water and steam dispensing units are suitably connected to the boiler 3. According to a possible embodiment, these dispensing units 31, 33 can be connected to the boiler by means of the outlet circuit 7.

As far as the outlet hydraulic circuit 7 is concerned, it comprises at least one outlet block 28 preferably monolithic and interposed between the boiler 3 and the coffee dispensing unit 6.

At least one dispensing duct or dispensing channel 29 is predefined in the outlet block 28 and communicating with a relative container 4 on one part and with the corresponding coffee dispensing unit 6 on the other, such as, for example, visible in the sectional view of FIG. 5A.

In the embodiment shown in the figures, each dispensing unit is provided with its outlet block 28, which is provided with a dispensing duct 29 fluidically connected to the dispensing unit 6, which, as is known, is preferably provided with a joint for constraining a filter-holder (not shown).

Despite this, the possibility that the outlet circuit 7, and in particular the outlet block 28, can be provided with two or more dispensing ducts 29 connected to respective dispensing units, such as, for example, described in EP2741645, is not to be excluded. Moreover, such as, for example, described in EP2741645, the outlet block can comprise one or more channels for the outflow of the steam and one hot water channeling channel respectively connected to one or more steam 33 or water 31 dispensing units.

Advantageously, the dispensing duct 29 is connected to the relative container 4 by means of an inlet port 29a. As will become clearer hereinafter, a flow regulating member, such as, for example, a valve 110, is arranged along the dispensing channel 29. This valve can be, for example, a manual control valve of the type with a needle plug.

Moreover, the outlet block 28 comprises at least one return duct 37 for each container 4, fluidically communicating with the dispensing channel 29 for the recirculation of the water flow towards the corresponding container 4.

More particularly, each coffee dispensing unit 6 comprises an electrovalve 120 that can be activated to allow the dispensing of the coffee and therefore the passage of the water towards the outside of the machine. This valve is put in communication with the relative dispensing duct 29 and with the relative return duct 37, inside which the water is recirculated if this electrovalve is closed.

The return duct 37 is then connected to the container by means of a tube 38.

The recirculated water is used to maintain the dispensing unit 6 at the desired temperature. The recirculation of water through the dispensing unit 6 and the container 4 is known in the sector as thermosiphon recirculation, since the recirculation motion can continue if no coffee dispensing is requested, and therefore the valve 120, which controls the flow from the dispensing duct 29 to the outlet of the dispensing unit 6 and therefore to the filter-holder, is activated.

The presence of the valve 110 or similar regulation means arranged on the dispensing duct 29, or in the return duct 37, advantageously allows to regulate the water recirculation flow and, therefore, consequently the temperature of the dispensing unit 6.

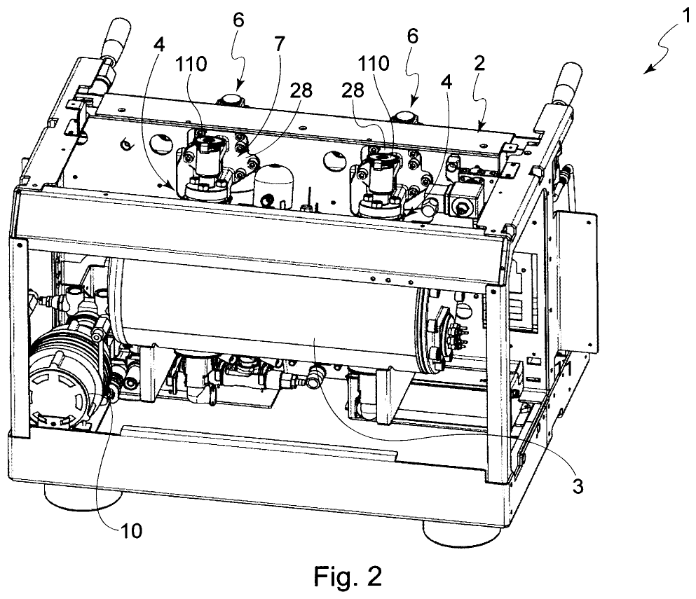

The recirculation regulation valve 110 is arranged above the outlet block 28 and in particular in the upper part of the dispensing duct 29, this way it can be easily accessed by an operator, such as, for example, visible in FIGS. 1 and 2, wherein the manual control handle of the valve 110 is visible above the machine.

Preferably, each container 4 has a joint 39 in which the tubes 11 and 38, respectively coming from the distributing element 80′, 80″ and from the outlet block 28, are merged. It should be noted that according to a possible embodiment, such as, for example, visible in the figures, the outlet block 28 can comprise a first part 28a combined with the boiler 3 and at least one second part 28b combined with one (or more) of the dispensing units 6. The two parts 28a, 28b are constrained to one another, for example in a reversible way.

For example, as visible in the figures, the first and the second parts 28a and 28b have a plurality of relative holes interconnected to one another by means of suitable connecting elements, for example of the threaded type.

The dispensing duct 29 and the return duct 37 will have a first portion arranged in the first part of the outlet block 28a and a second portion arranged in the second part of the outlet duct 28b combined with the dispensing unit 6, such as, for example, visible in the sectional view of FIG. 5A, wherein a vertical connecting duct is visible between the dispensing duct 29 and the return duct 37.

The embodiment shown in the figures provides an outlet block 28, for example comprising a first part 28a combined with the boiler, and a relative second part 28b for each dispensing unit 6 present on the machine. In other words, according to a possible embodiment, the outlet block 28, and generally the outlet circuit 7, is independent for each dispensing unit 6.

However, embodiments, such as, for example, the one described in EP2741645, wherein there are a first part 28a of the block and two second parts of the block 28b, where each of these second blocks 28b is adapted to connect the first block 28a to relative dispensing units 6 and possibly to the hot water and steam dispensing units 31, 33, are not to be excluded.

Embodiments, wherein the outlet block 28 only has a second block 28b adapted to connect the first block 28a to all of the dispensing units 6 and possibly to the water and steam dispensing units 31 and 33 are not to be excluded either.

The outlet block 28, and in particular the first part of the block 28a and/or the second part of the block 28b, if consisting of two parts, can be suitably constrained, preferably in a reversible way, to the supporting structure 2 of the machine.

At this point of the description, the operations of the machine according to the invention will become clearer. The most important steps of the operations of the machine are summarized here below by way of example.

First, the boiler of the machine is suitably filled with water.

With regard to this, the water coming from the supply line and entering the inlet block 8 passes through the passage mouth 9b to reach the boiler 3. As is known, there can be bypass or safety ducts to prevent the undesired loading of the boiler 3.

The boiler is loaded through a control valve 15, which can be connected to a level sensor of the boiler.

More specifically, according to a possible embodiment, the passage of the water in the mouth 9b of the inlet block 8 for the loading of the boiler is regulated by the valve 15, which is open until the water level in the boiler reaches the level sensor.

The boiler load valve 15 closes as soon as the water level in the boiler 3 reaches the sensor level, whenever present. Or the closing of the valve can be regulated manually.

If there is a low pressure valve, the water is not allowed to pass through the outlet port 9c of the inlet block 8 until the pressure reached a minimum predetermined value.

Once the pressure reaches the minimum predetermined value, which corresponds to the calibration value of the low pressure valve, the latter opens to allow the water to outflow towards the outlet port 9c and, therefore, towards one or more distributing elements 80′, 80″, passing through them into the containers 4.

In this operating condition, the water contained in the boiler 3 and in the containers 4 is still cold and, therefore, not suitable for dispensing the coffee.

By activating the heating element, and, therefore, the heating the water contained inside the boiler 3 and the consequent pressure increase necessary for obtaining the convective motion of the water between the containers 4 and the coffee dispensing units 6, as hereinafter explained in detail. As mentioned above, by effect of the conduction, also the water contained in the containers 4 is heated.

More particularly, the hottest portion of the water contained in the containers 4 is naturally collected in their upper part and enters the dispensing duct 29. Along this path, the water cools and goes back in the container 4 by passing through the return duct 37, since the electrovalve 120 of the relative coffee dispensing unit 6 is closed in this step. This way, a type of convective motion of the water is obtained inside the machine 1, also known as recirculation or thermosiphon circulation. By means of the regulating member 110, and in particular of the valve for example of the needle plug type (for example visible in the sectional view of FIG. 5A), the water recirculation flow can be regulated to quickly and effectively regulate the desired temperature for the dispensing unit 6.

When desiring to achieve the dispensing of the coffee, the user operates the pump 10, sending further water, cold and at a high pressure, into the inlet circuit 5.

This way, the introduced water crosses the inlet block 8, the outlet port 9c and enters one or more of the distributing elements 80′, 80″.

Through the distributing elements, and in particular through the meters 26, whenever provided, a predetermined quantity of water passes from the inlet opening 82′, 82″ of the distributing element to the distribution opening 83′, 83″, therefore entering the containers 4 by means of suitable connecting ducts 11.

The meters 26 are calibrated so that a sufficient quantity necessary for dispensing the correct quantity of coffee is introduced in the containers 4. The meters 26 are therefore operatively connected to the electrovalves 120 of the coffee dispensing units 6.

The water entering the containers 4 causes a pressure increase inside them and the consequent channeling of the water contained in the relative dispensing ducts 29 and in the relative return ducts 37 towards the corresponding coffee dispensing units 6. The mixing of the two water flows coming from the dispensing channel 29 and the return duct 37 can allow to reach the optimal temperature and to condense the steam present. The respective electrovalves 120 of the coffee dispensing units 6 are now open, therefore allowing the passage of water and the consequent dispensing of the coffee.

1. Machine (1) for dispensing espresso coffee comprising:
at least one boiler (3) for containing and heating the water;
at least one container (4) suitable to contain the water for dispensing the coffee;
at least one inlet hydraulic circuit (5) suitable to connect said boiler (3) and said container (4) to a water supply line;
at least one coffee dispensing unit (6);
at least one outlet hydraulic circuit (7) suitable to connect said at least one container (4) to said coffee dispensing unit (6);
characterized in that said inlet hydraulic circuit (5) comprises at least one inlet block (8) having at least one duct (9) for the water passage, the duct being provided with at least one inlet port (9a) connectable to a water supply line, with at least one passage mouth (9b) communicating with said boiler (3), and with at least one outlet port (9c) fluidically connected with at least one water distributing element (80′, 80″) to distribute the water to at least one container (4), said distributing element being provided with at least one inlet opening (82′, 82″) connectable to said outlet port (9c) of the inlet block (8) and with at least one distribution opening (83′, 83″) for the fluidic connection to said container (4).

2. Machine according to any one of the preceding claims, wherein said at least one distributing element (80′, 80″) is separable from said inlet block (8) and/or from a further distributing element (80′, 80″).

3. Machine according to claim 1 or 2, wherein said distributing element (80′, 80″) comprises at least one outlet opening (84′, 84″).

4. Machine according to any one of the preceding claims, comprising two or more distributing elements (80′, 80″) fluidically connected to one another, preferably in series.

5. Machine according to claim 4, wherein the outlet opening (84′, 84″) of a distributing element is connected to the inlet opening (82′, 82″) of a further distributing element.

6. Machine according to any one of the preceding claims, comprising a plurality of containers (4), each container (4) being fluidically connected to a distribution opening (83′, 83″) of a respective distributing element (80′, 80″).

7. Machine according to any one of the preceding claims, wherein at least one distributing element (80′, 80″) is coupled by coupling means (100a, 100b), preferably in a reversible way, to said inlet block (8) and/or to at least one further distributing element (80′, 80″).

8. Machine according to claim 7, wherein said coupling means (100a, 100b), preferably of reversible type, comprise a first coupling portion (100a) arranged on said distributing element (80′, 80″) and at least one second coupling portion (100b) arranged on said inlet block (8), or on a further distributing element (80′, 80″), or vice-versa.

9. Machine according to claim 7 or 8, wherein the second coupling portion (100b) is suitable to receive, or catch, at least part of the first coupling portion (100a), or vice-versa.

10. Machine according to any one of the preceding claims, wherein said inlet opening (82′, 82″) of said distributing element (80′, 80″) is complementarily configured for the coupling, preferably of reversible type, to said outlet port (9c) of said inlet block (8) or to said outlet opening (84′, 84″) of a further distributing element (80′, 80″).

11. Machine according to any one of the preceding claims, characterized by comprising restraining means (100c) to restrain at least one distributing element (80′, 80″) in a position mutually coupled with the inlet block (8) and/or with at least one further distributing element (80′, 80″).

12. Machine according to any one of the preceding claims, wherein at least one meter (26), preferably a volumetric meter, is combined with said distributing element (80′, 80″), said meter (26) being fluidically interposed between said inlet opening (82′, 82″) and said distribution opening (83′, 83″) of said distributing element (80′, 80″).

13. Machine according to any one of the preceding claims, comprising two or more distributing elements (80′, 80″) equal to one another, preferably said distributing elements having the same number of distribution openings (83′, 83″).

14. Machine according to any one of the preceding claims, comprising two or more distributing elements (80′, 80″) different from one another, preferably said distributing elements having a different number of distribution openings (83′, 83″).

15. Machine according to any one of the preceding claims, wherein said outlet hydraulic circuit (7) comprises at least one outlet block (28) interposed between said boiler (3) and at least one coffee dispensing unit (6) and in which at least one water dispensing duct (29) is predefined and communicates with said container (4) on one part and with said coffee dispensing unit (6) on the other, and at least one return duct (37), preferably distinct from said dispensing channel and communicating with said coffee dispensing unit (6) on one part and with said container on the other, and at least one regulating member (110) to regulate the water recirculation flow through said dispensing duct (29) and/or said return duct (37) into the container (4).

16. Machine according to claim 15, wherein said regulating member (110) is arranged in the dispensing duct (29), which channels water from the container (4) to the dispensing unit (6), or said regulating member (110) is arranged in the return duct (37) channeling water from the dispensing unit (6) to the container (4).

17. Machine according to claim 15 or 16, wherein said regulating member (110) comprises a valve, preferably a manually operated valve.

18. Machine according to claim 17, wherein said valve (110) comprises a needle plug.

19. Distributing element (80′, 80″) for the water distribution to at least one container (4) of a machine for dispensing coffee, said distributing element being provided with at least one inlet opening (82′, 82″) connectable to an outlet port (9c) of an inlet block (8) of the water of said machine, and with at least one distribution opening (83′, 83″) for the fluidic connection to said container (4).

20. Distributing element according to claim 19, wherein said at least one distributing element (80′, 80″) is separable from said inlet block (8) and/or from a further distributing element (80′, 80″).

21. Distributing element according to claim 19 or 20, characterized by comprising at least one outlet opening (84′, 84″).

22. Distributing element according to claim 21, wherein the outlet opening (84′, 84″) of said distributing element is connectable to the inlet opening (82′, 82″) of a further distributing element.

23. Distributing element according to any one of claims 19-22, characterized by being couplable by coupling means (100a, 100b), preferably in a reversible way, to said inlet block (8) and/or to at least one further distributing element (80′, 80″).

24. Distributing element according to claim 23, wherein said coupling means (100a, 100b), preferably of reversible type, comprise a first coupling portion (100a) arranged on said distributing element (80′, 80″) and at least one second coupling portion (100b) arranged on said inlet block (8), or on a further distributing element (80′, 80″), or vice-versa.

25. Distributing element according to claim 23 or 24, wherein the second coupling portion (100b) is suitable to receive, or catch, at least part of the first coupling portion (100a), or vice-versa.

26. Distributing element according to any one of claims 19 to 25, wherein said inlet opening (82′, 82″) of said distributing element (80′, 80″) is complementarily configured for the coupling, preferably of reversible type, to said outlet port (9c) of said inlet block (8) or to said outlet opening (84′, 84″) of a further distributing element (80′, 80″).

27. Distributing element according to any one of claims 19 to 26, characterized by comprising restraining means (100c) to restrain at least one distributing element (80′, 80″) in a position mutually coupled with said inlet block (8) and/or with at least one further distributing element (80′, 80″).

28. Distributing element according to any one of claims 19 to 27, wherein at least one meter (26), preferably a volumetric meter, is combined with said distributing element (80′, 80″), said meter (26) being fluidically interposed between said inlet opening (82′, 82″) and said distribution opening (83′, 83″) of said distributing element (80′, 80″).

29. Assembly comprising an inlet block (8) and one or more distributing elements (80′, 80″) for making up a hydraulic inlet circuit (5) of a coffee dispensing machine (1).

30. Machine for dispensing coffee, comprising:
at least one boiler (3) for containing and heating the water;
at least one container (4) suitable to contain the water for dispensing the coffee;
at least one inlet hydraulic circuit (5) suitable to connect said boiler (3) and said container (4) to a water supply line;
at least one coffee dispensing unit (6);
at least one outlet hydraulic circuit (7) suitable to connect said at least one container (4) to said coffee dispensing unit (6);
characterized in that said outlet hydraulic circuit (7) comprises at least one outlet block (28) interposed between said boiler (3) and at least one coffee dispensing unit (6) and in which at least one water dispensing duct (29) is predefined and communicates with said container (4) on one part and with said coffee dispensing unit (6) on the other, and at least one return duct (37), preferably distinct from said dispensing channel and communicating with said coffee dispensing unit (6) on one part and with said container on the other, and at least one regulating member (110) to regulate the water recirculation flow through said dispensing duct (29) and/or said return duct (37) into the container (4).

31. Machine according to claim 30, wherein said regulating member (110) is arranged in the dispensing duct (29), which channels water from the container (4) to the dispensing unit (6), or said regulating member (110) is arranged in the return duct (37) channeling water from the dispensing unit (6) to the container (4).

32. Machine according to claim 30 or 31, wherein said regulating member (110) comprises a valve, preferably a manually operated valve.

33. Machine according to claim 32, wherein said valve (110) comprises a needle plug.
